(19) United States
(12) Patent Application Publication
(10) Pub. No.: US 2008/0295663 A1
(43) Pub. Date: Dec. 4, 2008

(54) Cutting mechanism with adjustable position operating handle

(75) Inventors: Jung-Ya Hsieh, Taichung (TW); Hung-Jung Chiang, Taichung (TW); Ya-Lin Wu, Taichung (TW)

Correspondence Address: BACON & THOMAS, PLLC, 625 SLATERS LANE, FOURTH FLOOR, ALEXANDRIA, VA, 22314-1176, US

(73) Assignee: Rexon Industrial Corp., Ltd., Taichung (TW)

(21) Appl. No.: 12/153,838

(22) Filed: May 27, 2008

(30) Foreign Application Priority Data
May 28, 2007 (TW) 096118887

(51) Int. Cl. B23D 47/00; B23D 45/04; B26D 7/00; B27B 5/29; B27B 5/00

(52) U.S. Cl. 83/471.3

(57) ABSTRACT

A cutting mechanism includes a guard, a saw blade mounted within the guard, a motor for rotating the saw blade to cut a workpiece, and a handle unit. The handle unit includes an operating handle that has a first end and a second end connected to the first end, the first end of the operating handle being pivotally positioned along the top side of the guard in one of a number of positions including an initial position where a line between the first end and second end of the operating handle is kept in parallel to said saw blade, a left position 90-degrees leftwards from the initial position and a right position 90-degrees rightwards from the initial position.

### BACKGROUND

1. Field of the Invention

The present invention relates to a cutting mechanism and more particularly, to such a cutting mechanism that allows adjustment of the position of the operating handle.

2. Description of the Related Art

FIG. 1 illustrates a conventional cutting mechanism 10. According to this design, the cutting mechanism 10 is a miter saw, comprising a saw blade 12, a base 14, a motor 16, a saw arm 18, a start switch 20, and an operating handle 22. The base 14 is adapted for supporting a workpiece (not shown). The saw arm 18 has a rear end pivotally connected to the rear side 24 of the base 14 so that the saw arm 18 is movable upwards and downwards relative to the base 14, and a front part of the saw arm 18 is provided with a guard 26. The saw blade 12 is inserted into the guard 26. The motor 16 is installed on the saw arm 18, and is adapted for rotating the saw blade 12. The operating handle 22 is connected to the saw arm 18. The start switch 20 is mounted to the inner side of the operating handle 22, and is operable to start the motor 16. During operation, the user holds the operating handle 22 with one hand to operate the start switch 20 for rotating the saw blade 12 and to lower the saw arm 18, thus forcing the rotating saw blade 12 to cut the workpiece.

According to the aforesaid design, the operating handle 22 of the cutting mechanism 10 is fixedly provided above the saw blade 12 for holding by the left hand or right hand subject to the user's habit. According to the human factor engineering philosophy, the operating handle 22 is preferably disposed at the left side relative to the saw blade 12 if the user is left handed. Alternatively, the operating handle 22 is preferably disposed at the right side relative to the saw blade 12 if the user is right handed. However, this design does not allow adjustment of the operating handle 22 to fit different operation requirements.

### SUMMARY

The present disclosure provides an embodiment of a cutting mechanism, which eliminates the above mentioned drawbacks.

According to one aspect of the present disclosure, the cutting mechanism comprises a guard, a saw blade mounted within the guard, a motor for rotating the saw blade to cut a workpiece, and a handle unit. The handle unit comprises an operating handle that has a first end and a second end connected to the first end in a linear manner. The first end of the operating handle is pivotally positioned along the top side of the guard in one of at least three positions including an initial position where a line between the first end and second end of the operating handle is maintained parallel to said saw blade, a left, first position oriented in a first direction 90-degrees leftwards from the initial position and a right, second position oriented in a second direction opposed to the first direction 90-degrees rightwards from the initial position.

According to another aspect of the present disclosure, the handle unit further comprises a carrying handle fixedly mounted on the guard above the saw blade. Further, the first end of the operating handle is pivotally connected to a first end of the carrying handle so that the operating handle is movable relative to the carrying handle and selectively positionable in one of the aforesaid at least three positions. Further, the operating handle comprises a first engagement device disposed at the first end thereof, and the carrying handle comprises a second engagement device disposed at the first end thereof and adapted for engaging the first engagement device of the operating handle to lock the operating handle in the selected position.

According to still another aspect of the present disclosure, the cutting mechanism further comprises a positioning device. The positioning device comprises a rod member and a driving device. The rod member is inserted through the first end of the operating handle into the first end of the carrying handle to pivotally connect the operating handle to the carrying handle. The rod member has a first end. The driving device is operable to move the rod member between a locking position where the first end of the rod member is stopped against the first end of the operating handle, and an unlocking position where the first end of the rod member is disengaged from the first end of the operating handle. Therefore, the user can operate the driving device to move the rod member relative to the first end of the operating handle, thereby controlling engagement between the first engagement device and the second engagement device. When the first engagement device and the second engagement device are engaged together, the operating handle is locked in the selected position. When the first engagement device is disengaged from the second engagement device, the operating handle is movable relative to the carrying handle and adjustable to the desired position.

### BRIEF DESCRIPTION OF THE DRAWINGS

FIG. 1 is an elevational view of a cutting mechanism according to the prior art.

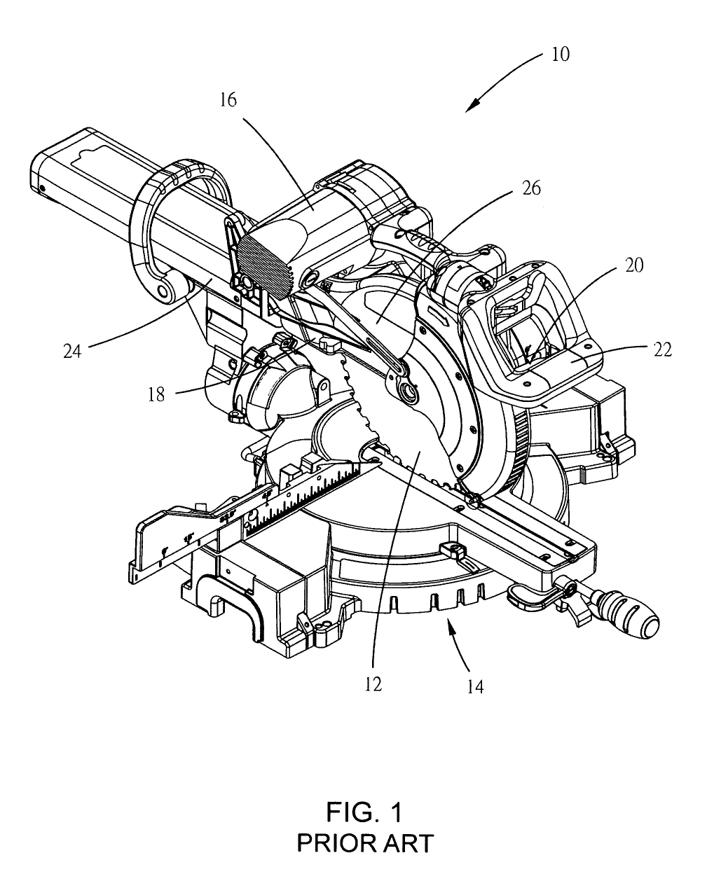

FIG. 2 is an elevational view of an exemplary embodiment of a cutting mechanism in accordance with the present disclosure.

FIG. 3 is similar to FIG. 2 but showing the operating handle moved 90-degrees horizontally leftwards from the initial position.

FIG. 4 is similar to FIG. 2 but showing the operating handle moved 90-degrees horizontally rightwards from the initial position.

FIG. 5 is a schematic drawing of a part of the embodiment of FIG. 2, showing the connection structure between the carrying handle and the operating handle.

FIG. 6 is a schematic drawing showing the engagement structure between the operating handle and the carrying handle.

### DETAILED DESCRIPTION OF AN EXEMPLARY EMBODIMENT

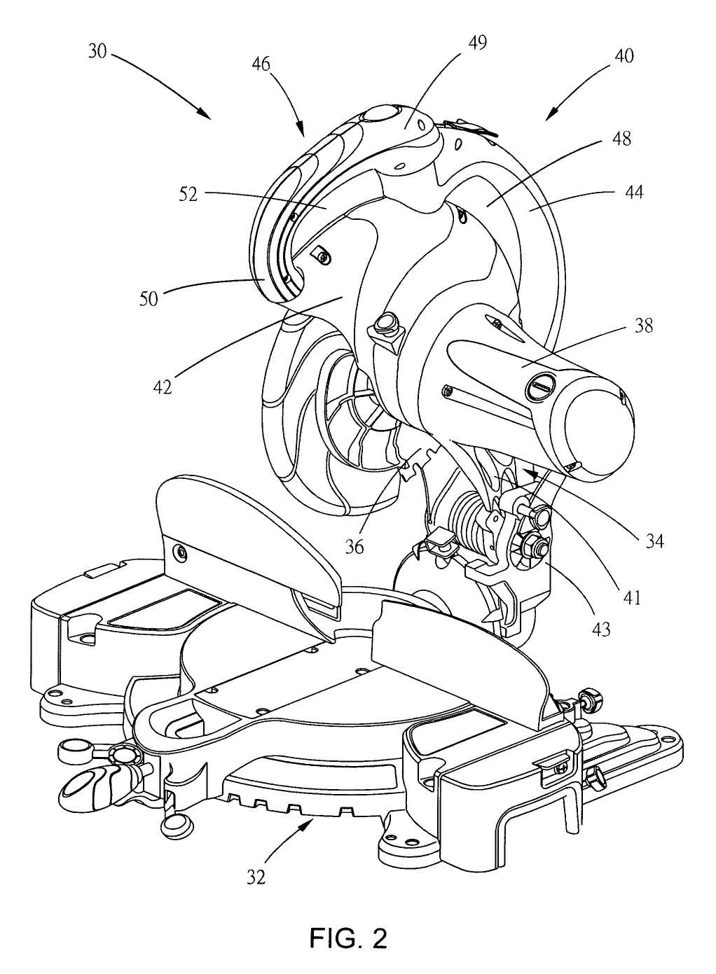

Referring to FIG. 2, a cutting mechanism 30 is shown in accordance with an exemplary embodiment of the present disclosure. According to the exemplary embodiment, the cutting mechanism 30 is a miter saw, comprising a base 32, a saw arm 34, a saw blade 36, a motor 38, a handle unit 40, and a start switch (not shown). The base 32 is adapted for carrying a workpiece (not shown) for cutting. The saw arm 34 has a rear end 41 pivotally connected to the rear side 43 of the base 32 so that the saw arm 34 is movable downwards toward the base 32. The other end, namely, the front end of the saw arm 34 is provided with a guard 42. The saw blade 36 is inserted into the guard 42, each having a left side and a right side. The motor 38 is mounted to the saw arm 34, and is adapted for rotating the saw blade 36 to cut the workpiece.

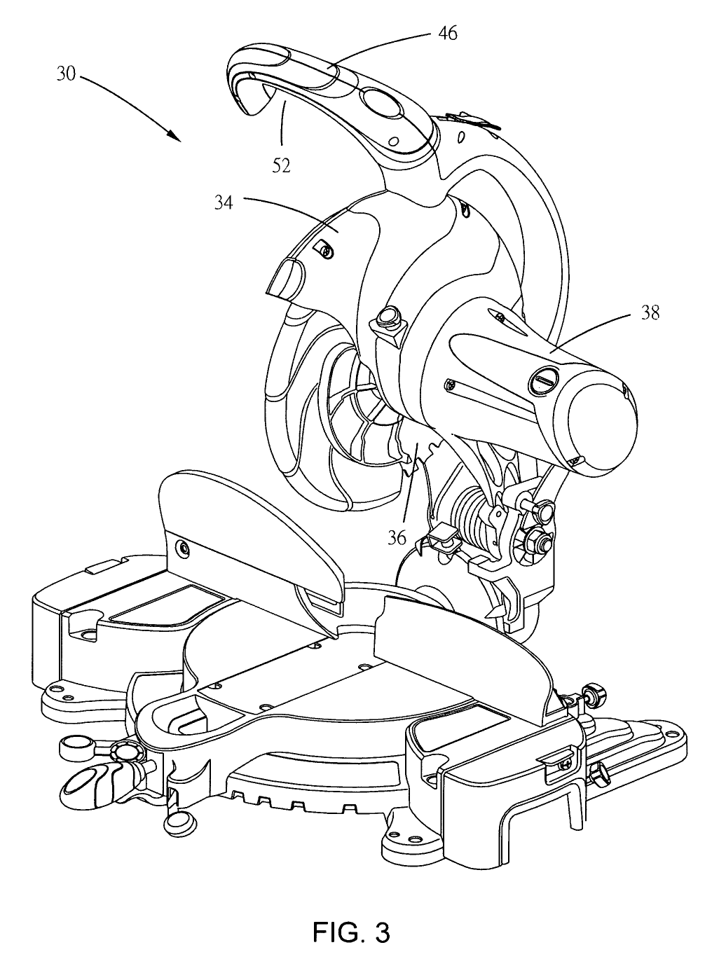

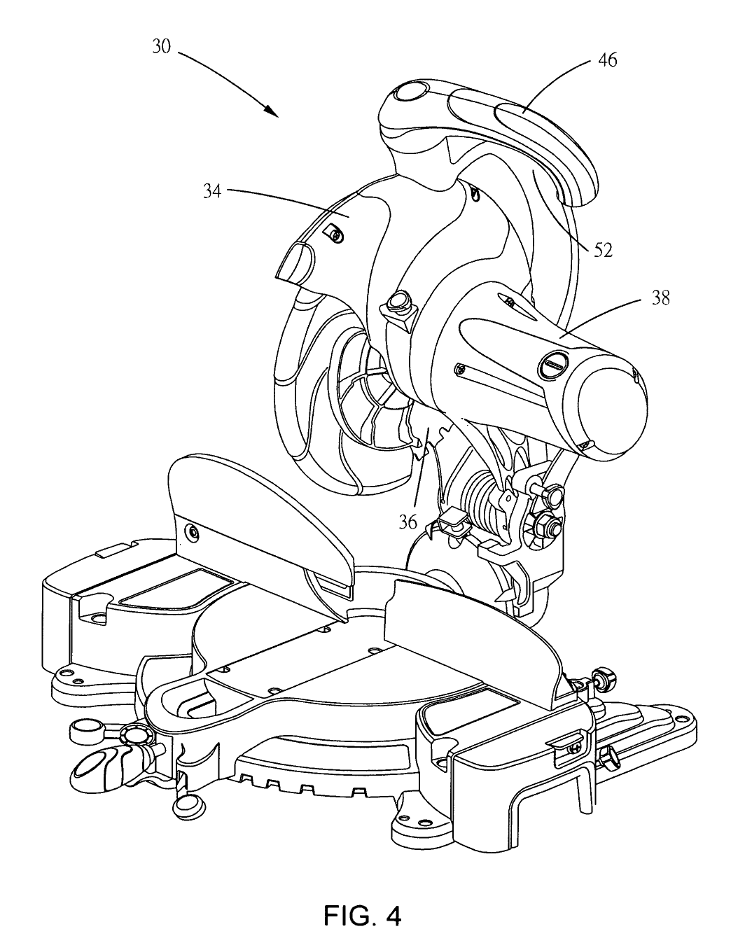

The handle unit 40 comprises a carrying handle 44 and an operating handle 46. The carrying handle 44 shows a U-shaped profile, having the front and rear ends thereof respectively affixed to the saw arm 34 such that the carrying handle 44 is vertically disposed at the top side of the saw arm 34 above the saw blade 36 and, a space 48 is defined between the saw arm 34 and the carrying handle 44 for the insertion of the user's hand to grasp the carrying handle 44 and for lifting the cutting mechanism 30. The operating handle 46 shows a linear U-shaped profile, having a rear end 49 pivotally connected to the front end of the carrying handle 44 above the guard 42 and a front end 50 that is not affixed to the guard 42. Therefore, the user can move the operating handle 46 to shift the front end 50 to the left side or right side among at least three positions, for example, the initial position where the connection line between the front end 50 and rear end 49 of the operating handle 46 is maintained parallel to the saw blade 36 (see FIG. 2), a left position where the operating handle 46 is moved 90-degrees horizontally leftwards from the initial position (see FIG. 3), and a right position where the operating handle 46 is moved 90-degrees horizontally rightwards from the initial position (see FIG. 4).

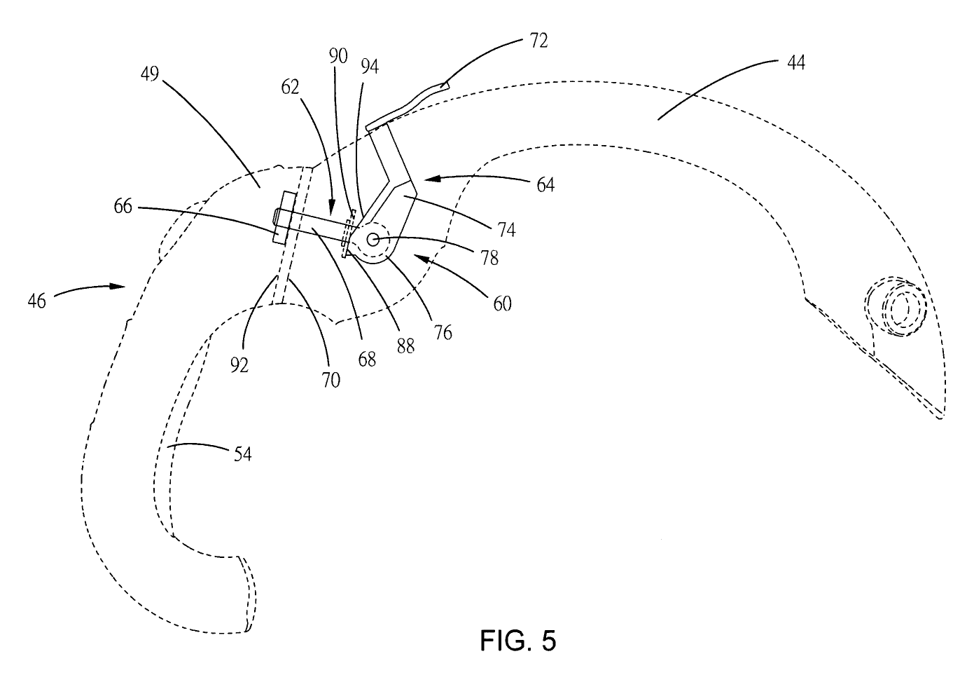

Referring to FIGS. 2, 3, and 4, the operating handle 46 defines therein an opening 52 through which the user can insert one hand to grasp the operating handle 46 and to further move the saw arm 34 to lower the saw blade 36. The start switch 54 (see FIG. 5) is for switching on/off the motor 38. The start switch 54 is mounted along an inner side of the operating handle 46 so that when the user is holding the operating handle 46 with one hand, the user can conveniently operate the start switch 54 with the same hand. When the user presses the start switch 54, the motor 38 is started to rotate the saw blade 36. At this time, the user can lower the rotating saw blade 36 to cut the workpiece.

Referring to FIG. 5, the cutting mechanism 30 further comprises a positioning structure 60. The positioning structure 60 comprises a rod member 62 and a driving device 64. The rod member 62 has a head 66 and a body 68 extending from the head 66. The body 68 is a pivot axle inserted through the rear end 49 of the operating handle 46 and a junction plane 70 at the front end of the carrying handle 44 to pivotally connect the operating handle 46 to the carrying handle 44. The head 66 is disposed in the rear end 49 of the operating handle 46, having a cross section greater than the body 68 so that the head 66 is not movable through the junction plane 70. The driving device 64 comprises a lever 72, a connection rod 74, a cam 76 and an axle 78. The connection rod 74 has one end fixedly connected to the lever 72, and the other end fixedly connected to the cam 76. Therefore, the user can operate the lever 72 to move the cam 76. The axle 78 connects the cam 76 and one end of the body 68 in such a manner that at least one of the cam 76 and the body 68 is rotatable relative to the axle 78. Further, the axle 78 is the axis of rotation of the cam 76.

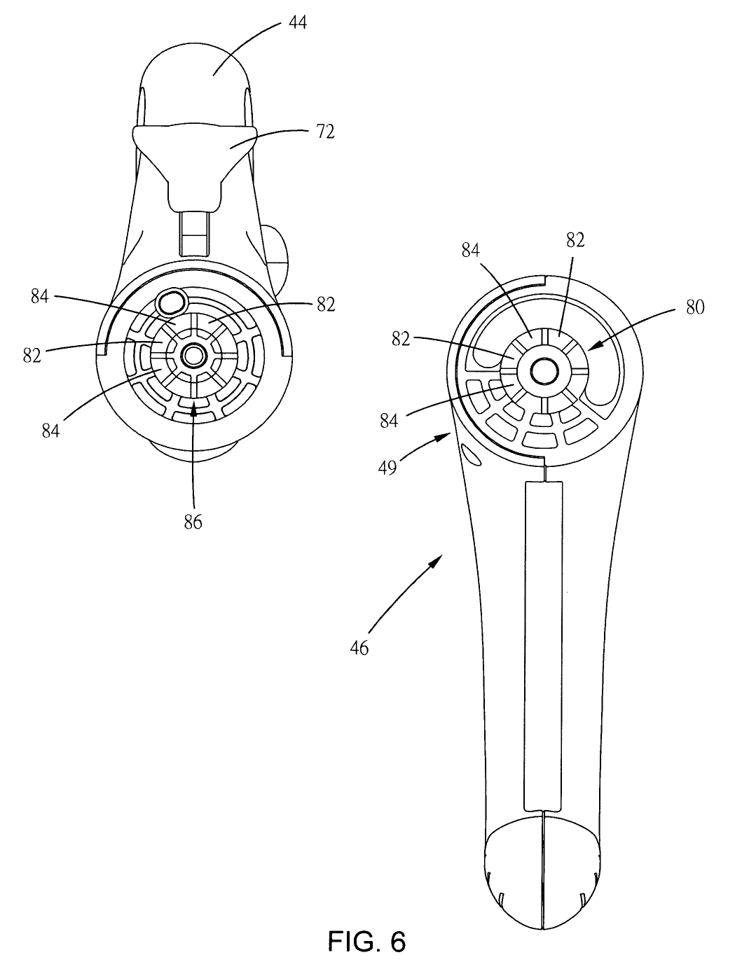

Referring to FIG. 6, the junction structure between the operating handle 46 and the carrying handle 44 is a toothed engagement structure. The operating handle 46 comprises a first engagement device 80 arranged in an annular manner along an end edge of the rear end 49. The first engagement device 80 is comprised of a plurality of protrusions 82 and recesses 84 alternatively and equiangularly arranged around the center of the end edge of the rear end 49. The carrying handle 44 comprises a second engagement device 86 arranged in a complementary manner relative to the first engagement device 80.

When the lever 72 is moved downwards to a locking position (see FIG. 5), the cam 76 is moved to force a first sidewall 88 thereof against a wall 90 at the front end of the carrying handle 44. At this time, the rod member 62 is pulled backwards through the axle 78 in a direction perpendicular to the junction plane 70, causing the head 66 of the rod member 62 to be forced against an inside wall 92 of the rear end 49 of the operating handle 46, and therefore the first engagement device 80 is forced into engagement with the second engagement device 86. After engagement between the first engagement device 80 and the second engagement device 86, the operating handle 46 is prohibited from moving relative to the carrying handle 44. When the lever 72 is lifted from the locking position, the cam 76 is rotated counter-clockwise to disengage the first sidewall 88 from the wall 90 of the carrying handle 44. At this time, a second sidewall 94 of the cam 76 is in proximity to the wall 90 of the carrying handle 44. Because the distance between the second sidewall 94 and the center of rotation of the cam 76 is smaller than the distance between the first sidewall 88 and the center of rotation of the cam 76, the rod member 62 is loosened, and the head 66 is not pressed against the inside wall 92 of the operating handle 46, and therefore the operating handle 46 can be pulled outwards to disengage the first engagement device 80 from the second engagement device 86. The operating handle 46 can then turned relative to the carrying handle 44 to a desired position. After the operating handle 46 has been turned to the desired position, the lever 72 is returned to the locking position to lock the operating handle 46 to the carrying handle 44 in the adjusted position.

According to the exemplary embodiment, the first engagement device 80 and the second engagement device 86 are engageable with each other at selected positions in order to determine the positioning angle of the operating handle 46, i.e., the number of the protrusions 82 and recesses 84 is predetermined and they are equiangularly spaced around the center of the respective engagement device at a predetermined angle, thereby determining the positioning angles in which the operating handle 46 is selectively positionable.

In conclusion, the carrying handle 44 in the aforesaid preferred embodiment of the present disclosure is directly affixed to the saw arm 34 so that the user can grasp the carrying handle 44 to conveniently carry the cutting mechanism 30. The operating handle 46 has its rear end 49 pivotally connected to the front end of the carrying handle 44 above the saw blade 36 and selectively positionable in at least one of three predetermined positions, i.e., an initial position, a left position 90-degrees leftwards from the initial position, and a right position 90-degrees rightwards from the initial position. The number of positions in which the operating handle 46 is selectively positionable is determined subject to the number of the protrusions 82 and recesses 84 of the first engagement device 80 and the second engagement device 86. The user can operate the lever 72 of the driving device 64 to control the position of the head 66 of the rod member 62 relative to the inside wall 92 of the operating handle 46 and to further control engagement/disengagement between the first engagement device 80 and the second engagement device 86, and therefore the user can adjust the operating handle 46 to the desired position conveniently and quickly, i.e., the user can adjust the operating handle 46 to the left side relative to the saw blade 36 when using the left hand to operate the operating handle 46 or to the right side relative to the saw blade 36 when using the right hand to operate the operating handle 46

Although a particular embodiment of the invention has been described in detail for purposes of illustration, various modifications and enhancements may be made without departing from the spirit and scope of the invention. Accordingly, the invention is not to be limited except as by the appended claims

What is claimed is:

1. A cutting mechanism comprising:
a guard;
a saw blade mounted within said guard, said saw blade having a left side and a right side; and
a handle unit comprising an operating handle having a first end extending to a second end in a linear manner, the first end of said operating handle pivotally positioned along a top side of said guard in one of at least three positions including (i) an initial position where the operating handle is maintained parallel to said saw blade, (ii) a first position oriented in a first direction away from said initial position and (iii) a second position oriented in a second direction away from said initial position and opposed to said first direction.

2. The cutting mechanism according to claim 1, wherein said first position is oriented 90-degrees leftwards from said initial position, and said second position is oriented 90-degrees rightwards from said initial position.

3. The cutting mechanism according to claim 1, wherein a center of rotation of the first end of said operating handle is disposed above said saw blade.

4. The cutting mechanism according to claim 3, wherein said handle unit further comprises a carrying handle fixedly mounted on said guard above said saw blade, said carrying handle having a first end; the first end of said operating handle pivotally connected to the first end of said carrying handle.

5. The cutting mechanism according to claim 4, further comprising a positioning device having a rod member and a driving device, said rod member having a first end, and inserted through the first end of said operating handle into the first end of said carrying handle to pivotally connect said operating handle to said carrying handle, said driving device operable to move said rod member between a locking position where the first end of said rod member is arranged to stop against the first end of said operating handle and an unlocking position where the first end of said rod member is disengaged from the first end of said operating handle.

6. The cutting mechanism according to claim 5, wherein said driving device further comprises a cam and an axle, said cam connected to and rotated on said axle, and having a center of rotation located along a central axis of said axle; wherein said rod member has a second end connected to said axle.

7. The cutting mechanism according to claim 6, wherein said cam is arranged to rotate against one sidewall of the first end of said carrying handle, and said axle is arranged to move said rod member and force the first end of said rod member against the first end of said operating handle upon rotation of said cam to push against the sidewall of the first end of said carrying handle.

8. The cutting mechanism according to claim 4, wherein said operating handle comprises a first engagement device disposed at the first end thereof, and said carrying handle comprises a second engagement device disposed at the first end thereof and adapted for engaging the first engagement device of said operating handle.

9. A cutting mechanism comprising:
a guard;
a saw blade mounted within said guard, said saw blade having a left side and a right side; and
a handle unit comprising a carrying handle and an operating handle, said carrying handle affixed to said guard above said saw blade, said operating handle having a first end extending to a second end in a linear manner, the first end of said carrying handle pivotally connected to one end of said carrying handle at a location above said saw blade in one of at least three positions including (i) an initial position where the operating handle is maintained parallel to said saw blade, (ii) a first position oriented in a first direction away from said initial position and (iii) a second position oriented in a second direction away from said initial position and opposed to said first direction.

10. The cutting mechanism according to claim 9, wherein said first position is oriented 90-degrees leftwards from said initial position, and said second position is oriented 90-degrees rightwards from said initial position.

11. The cutting mechanism according to claim 10, further comprising a positioning device having a rod member and a driving device, said rod member having a first end, and inserted through the first end of said operating handle into the first end of said carrying handle to pivotally connect said operating handle to said carrying handle, said driving device operable to move said rod member between a locking position where the first end of said rod member is arranged to stop against the first end of said operating handle and an unlocking position where the first end of said rod member is disengaged from the first end of said operating handle.

12. The cutting mechanism according to claim 11, wherein said driving device further comprises a cam and an axle, said cam connected to and rotated on said axle, and having a center of rotation located along a central axis of said axle; wherein said rod member has a second end connected to said axle.

13. The cutting mechanism according to claim 12, wherein said cam is arranged to rotate against one sidewall of the first end of said carrying handle, and said axle is arranged to move said rod member and force the first end of said rod member against the first end of said operating handle upon rotation of said cam to push against the sidewall of the first end of said carrying handle.

14. A cutting mechanism comprising:
a guard;
a saw blade mounted within said guard, said saw blade having a left side and a right side; and
a handle unit comprising a carrying handle and an operating handle, said carrying handle affixed to said guard above said saw blade, said operating handle having a first end extending to a second end in a linear manner, the first end of said carrying handle pivotally connected to a first end of said carrying handle at a location above said saw blade in one of at least three positions including (i) an initial position where the operating handle is maintained parallel to said saw blade, (ii) a first position oriented 90-degrees leftwards from said initial position and (iii) a second position oriented 90-degrees rightwards from said initial position, said operating handle comprising a first engagement device disposed at the first end thereof, said carrying handle comprising a second engagement device disposed at the first end thereof and adapted for engaging the first engagement device of said operating handle.
